(19) United States
(12) Patent Application Publication
(10) Pub. No.: US 2014/0082392 A1
(43) Pub. Date: Mar. 20, 2014

(54) SEMICONDUCTOR DEVICE AND COMMUNICATION METHOD

(71) Applicant: KABUSHIKI KAISHA TOSHIBA, Tokyo (JP)

(72) Inventors: Masanori NISHIZAWA, Kanagawa (JP); Ken OKUYAMA, Chiba (JP)

(73) Assignee: KABUSHIKI KAISHA TOSHIBA, Tokyo (JP)

(21) Appl. No.: 13/779,706

(22) Filed: Feb. 27, 2013

(30) Foreign Application Priority Data
Sep. 19, 2012 (JP) 2012-206067

(51) Int. Cl. G06F 1/32

(52) U.S. Cl. CPC G06F 1/3234
USPC 713/323

(57) ABSTRACT

According to an embodiment, a communication control section which is a semiconductor device includes a communication circuit capable of operating in at least two operation modes of normal mode L0 and low-power mode L0s. A power management control section controls an UpdateFC transmission control section to make a transition of operation mode of the communication circuit to low-power mode L0s and transmit an UpdateFC signal at intervals of a second time period d2 longer than a first time period d1 if, during operation of the communication circuit in normal mode L0, transmission data is absent and reception data is absent in a reception buffer and controls the UpdateFC transmission control section to make a transition of the operation mode of the communication circuit to normal mode L0 if, during operation of the communication circuit in low-power mode L0s, transmission data is present or the second time period d2 elapses.

### CROSS-REFERENCE TO RELATED APPLICATION

This application is based upon and claims the benefit of priority from the Japanese Patent Application No. 2012-206067, filed on Sep. 19, 2012; the entire contents of which are incorporated herein by reference.

### FIELD

An embodiment described herein relates generally to a semiconductor device and a communication method.

### BACKGROUND

Data communication has been made between chips, between boards, and between systems, and various architectures are available for data communication.

An example of the various architectures is the PCI (Peripheral Component Interconnect) Express standard.

Some of the various architectures also include one including a function for achieving a saving in power consumption at the time of data communication. The function performs control for a transition to low-power mode under a predetermined condition. For example, a hardware-based low-power mode called ASPM (Active State Power Management) is defined in the above-described PCI Express architecture standard.

An architecture for data communication generally has a flow control mechanism for telling the status of a reception buffer and is configured to perform periodic transmission and reception of flow control information. For example, in the PCI Express architecture, a transition of link status from the L0s state to the L0 state occurs in an LTSSM (Link Training and Status State Machine) mechanism, and transmission and reception of an UpdateFC packet which is flow control information are performed.

However, in the flow control mechanism, even if a communication circuit enters low-power mode, the communication circuit is made to exit low-power mode for transmission and reception of flow control information. A transition to normal mode occurs periodically. In the PCI Express architecture, an UpdateFC packet needs to be transmitted, for example, once every 30 μs (microseconds). Thus, there is a limit to a reduction in power consumption even in low-power mode.

### BRIEF DESCRIPTION OF THE DRAWINGS

FIG. 1 is a configuration diagram of a personal computer according to the present embodiment;

FIG. 2 is a block diagram showing a configuration of a communication control section 12a according to the present embodiment;

FIG. 3 is a flow chart showing a flow of state transition by processing of a power management control section 25 according to the present embodiment;

FIG. 4 is a time chart for describing a case where a change from the 1.0 state to the L0s state and a change from the L0s state to the L0 state are alternated with passage of time t;

FIG. 5 is a time chart for describing a case where duration of the L0s state is extended, according to the present embodiment; and

FIG. 6 is a time chart for describing a case where the L0s state continues when an expanded L0s function is enabled also in a communication partner, according to the present embodiment.

### DETAILED DESCRIPTION

A semiconductor device according to an embodiment is a semiconductor device including a communication circuit capable of operating in at least two operation modes including a first operation mode and a second operation mode lower in power consumption than the first operation mode, including a send buffer configured to store transmission data, a reception buffer configured to store reception data, a predetermined information transmission section configured to transmit predetermined information at intervals of a first time period, and a power management control section. The power management control section controls the predetermined information transmission section to make a transition of an operation mode of the communication circuit to the second operation mode and transmit the predetermined information at intervals of a second time period longer than the first time period if, during operation of the communication circuit in the first operation mode, the transmission data is absent and the reception data is absent in the reception buffer and controls the predetermined information transmission section to make a transition of the operation mode of the communication circuit to the first operation mode and transmit the predetermined information at intervals of the first time period if, during operation of the communication circuit in the second operation mode, the transmission data is present or the second time period elapses.

### (Overall Configuration)

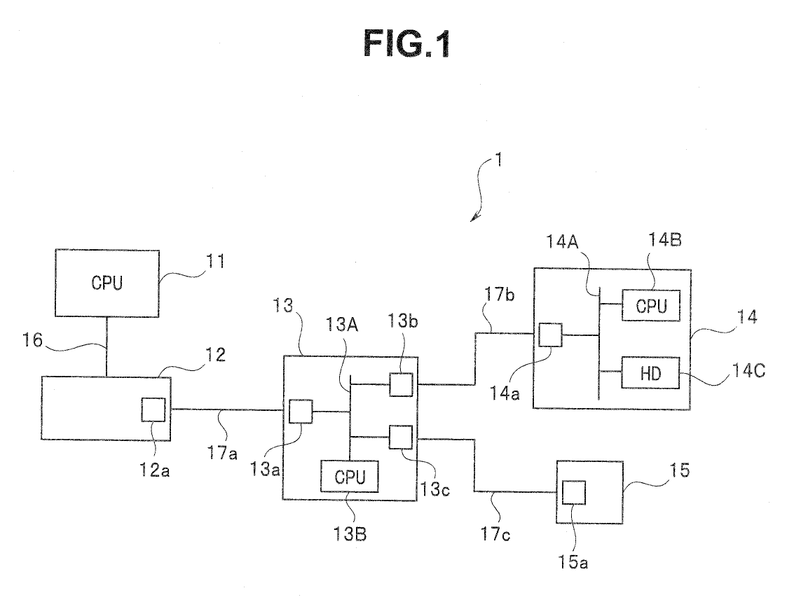

FIG. 1 is a configuration diagram of a personal computer according to the present embodiment. A personal computer (hereinafter referred to as a PC) 1 includes a CPU (central processing unit) 11 configured to perform overall control of the PC 1. a root complex 12 constituting a top-level I/O structure, a switch 13, and devices 14 and 15.

The CPU 11 and the root complex 12 are mounted on a mother board (not shown). The root complex 12 is connected to the CPU 11 by a bus 16. The root complex 12 is connected to the switch 13 by a serial interface 17a. The switch 13 is connected to the device 14 by a serial interface 17b and is further connected to the device 15 by a serial interface 17c. The device 14 serving as an end point is. for example, a hard disk drive device, and the device 15 is an SSD (solid-state drive) using, for example, a semiconductor device memory. The switch 13 is a device which allows connection between the root complex 12 and a plurality of devices.

The root complex 12 has a communication control section 12a for communication with the switch 13 via the serial interface 17a. The switch 13 has a communication control section 13a for communication with the root complex 12 via the serial interface 17a, a communication control section 13b for communication with the device 14 via the serial interface 17b, and a communication control section 13c for communication with the device 15 via the serial interface 17c. The device 14 also has a communication control section 14a for communication with the switch 13 via the serial interface 17b. Similarly, the device 15 has a communication control section 15a for communication with the switch 13 via the serial interface 17c.

The communication control section 12a is included in a single semiconductor device together with other circuits of the root complex 12. Note that the communication control section 12a may be implemented as a one-chip semiconductor device on the mother board.

Other communication control sections 13a, 13b, 13c, 14a, and 15a may each be formed as a single semiconductor device or be included in a single semiconductor device together with a CPU and other circuits.

The devices can communicate with each other via the serial interfaces 17a, 17b. and 17c by a communication protocol of the PCI Express architecture. A power saving function of the PCI Express architecture can be implemented between the devices connected to the serial interfaces 17a, 17b, and 17c (between the root complex 12 and the switch 13, between the switch 13 and the device 14, and between the switch 13 and the device 15 in FIG. 1).

That is, each of the communication control sections that are semiconductor devices has a communication circuit capable of operating in normal mode and in low-power mode. When a power saving function places operation mode into low-power mode, the communication circuit, a controller, and the like in the communication control section operate in low-power mode. In other words, each communication control section has a communication circuit capable of operating in at least two operation modes, a first operation mode and a second operation mode lower in power consumption than the first operation mode.

The switch 13 has a CPU 13B which is connected to an internal bus 13A. The communication control sections 13a, 13b, and 13c are connected to the bus 13A.

Similarly, the device 14 has a CPU 14B and a hard disk device (HD) 14C which are each connected to an internal bus 14A. The communication control section 14a is connected to the bus 14A.

For example, when the communication control section 12a of the root complex 12 receives data which is to be transmitted to the switch 13 (transmission data) from the CPU 11 via the bus 16, the communication control section 12a transmits the transmission data to the communication control section 13a of the switch 13 via the serial interface 17a. The communication control section 12a of the root complex 12 also receives data from the communication control section 13a of the switch 13 (reception data) via the serial interface 17a.

Similarly, when the communication control section 13a of the switch 13 receives packet data which is to be transmitted to the root complex 12 from the device 14 or 15, the communication control section 13a transmits the packet data to the communication control section 12a of the root complex 12 via the serial interface 17a. The communication control section 13a of the switch 13 also receives data from the communication control section 12a of the root complex 12 via the serial interface 17a.

The other communication control sections 13b, 13c, 14a, and 15a each perform transmission and reception of data via the corresponding serial interface 17b or 17c.

The individual communication control sections are each constructed as a circuit in the corresponding semiconductor device.

### (Configuration of Communication Control Section)

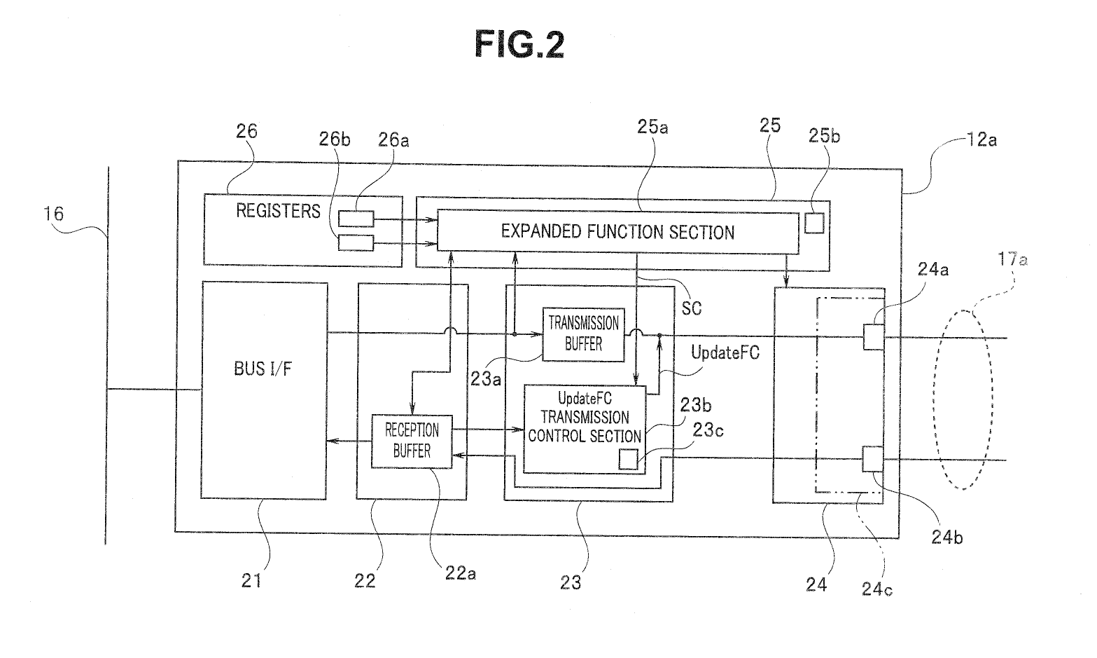

FIG. 2 is a block diagram showing a configuration of the communication control section 12a. Although only the configuration of the communication control section 12a will be described here, the other communication control sections 13a, 13b, 13c, 14a, and 15a have a same configuration as the configuration of the communication control section 12a, and a description of the configuration will be omitted.

The communication control section 12a has a bus interface (hereinafter abbreviated as a bus I/F) 21, a transaction section 22. a data link section 23, a physical circuit section 24, a power management control section 25, and a register section 26.

The bus I/F 21 is an interface section for connecting to the bus 16 connected to the CPU 11 and includes a bus controller and the like.

The transaction section 22 is a processing section corresponding to the transaction layer of the PCI Express architecture and includes a reception buffer 22a. Reception data received via the serial interface 17a is stored in the reception buffer 22a.

The data link section 23 is a processing section corresponding to the data link layer of the PCI Express architecture and includes a transmission buffer 23a and an UpdateFC transmission control section 23b. The UpdateFC transmission control section 23b includes a timer 23c. Transmission data from the CPU 11 which is received via the bus 16 is stored in the transmission buffer 23a. The transmission data stored in the transmission buffer 23a is output to the serial interface 17a.

The UpdateFC transmission control section 23b monitors availability of the reception buffer 22a. If the availability of, i.e. available space in the reception buffer 22a changes, the UpdateFC transmission control section 23b transmits an UpdateFC signal which is flow control information including information on the available space in the reception buffer 22a to the communication control section 13a that is a communication control section as a communication partner. In PCI Express architecture, the UpdateFC transmission control section 23b constitutes a predetermined information transmission section (flow control section) configured to transmit flow control information as predetermined information at intervals of a predetermined time period.

According to the PCI Express standard, the UpdateFC transmission control section 23b generally transmits an UpdateFC signal as flow control information to the communication control section 13a as the communication partner at intervals of a predetermined time period d1 as a set time period ST1 which is set in the timer 23c even if transmission data is absent, and the reception buffer 22a is empty. For example, the predetermined time period d1 is 30 μs. That is, even if transmission data is absent, and the reception buffer 22a is empty, the UpdatcFC transmission control section 23b transmits an UpdateFC signal including data indicating that the reception buffer 22a is empty to the communication partner each time the timer 23c expires.

In the present embodiment, the set time period ST1 of the timer 23c can be changed based on a transmission interval control signal SC from the power management control section 25 (to be described later). As will be described later, under a predetermined situation, the power management control section 25 transmits a transmission interval control signal SC to the UpdateFC transmission control section 23b to extend the set time period ST1 of the timer 23c. For example, the set time period ST1 is changed from the predetermined time period d1 (30 μs) to a predetermined time period d2 (180 μs). As a result, a transmission interval control signal SC extends intervals at which an UpdateFC signal as flow control information output from the UpdateFC transmission control section 23b is transmitted.

The physical circuit section 24 is a processing section corresponding to the physical layer of the PCI Express architecture and includes various circuits for communication via the serial interface 17a constituting one link, such as a driver, a parallel-to-serial converter, and a serial-to-parallel converter.

The physical circuit section 24 also includes a differential circuit 24a for transmitting a transmission packet which is transmission data as a differential signal and a differential circuit 24b for receiving a reception packet which is a differential signal. Note that although one link includes only one lane here, one link may include a plurality of lanes. The physical circuit section 24 thus includes a communication circuit 24c configured to transmit transmission data and receive reception data in serial data format.

The power management control section 25 is a processing section configured to perform a function of saving power consumed by the communication control section 12a and is a processing section for performing an ASPM function. The power management control section 25 includes an expanded function section 25a and a timer section 25b. ASPM controls circuit operation in low-power mode (L0s) by hardware. The timer section 25b includes various timers to be used by the power management control section 25.

The register section 26 is a circuit including a plurality of registers for storing various pieces of data and includes two expanded L0s enable registers (hereinafter referred to first and second enable registers) 26a and 26b.

The first enable register 26a is a register for setting information on whether to enable an expanded L0s function (flow control information delay mode) to be described later. As will be described later, the expanded L0s function is a function of continuing the L0s state corresponding to low-power mode for long and is performed by the expanded function section 25a. That is, the first enable register 26a of the communication control section 12a can set the LUpdateFC transmission control section 23b to transmit an UpdateFC signal at intervals of the time period d2 longer than the time period d1.

The second enable register 26b is a register for setting information on whether an expanded L0s function is also set in the communication control section 13a of the switch 13 that is a device as the communication partner. The second enable register 26b can thus set configuration information for the communication partner.

To enable the expanded L0s function, predetermined information is set in the first enable register 26a. If the expanded L0s function is enabled, the expanded L0s function extends the set time period of the timer 23c in the UpdateFC transmission control section 23b.

In the present embodiment, if “1” as the predetermined information is set in the first enable register 26a, the expanded L0s function of the power management control section 25 is enabled. On the other hand, if “0” is set in the first enable register 26a. the expanded L0s function of the power management control section 25 is disabled. And if “1” as the predetermined information is set in the second enable register 26b, the expanded L0s function is set in a device as the communication partner. On the other hand, if “0” is set in the second enable register 26b, the expanded L0s function is not set in a device as the communication partner.

As will be described later, if transmission data is absent, and the reception buffer 22a is empty when the first enable register 26a is set to “1”, and the second enable register 26b is set to “0,” intervals at which an UpdateFC signal is transmitted are changed and extended to the time period d2 so as to be shorter than 200 μs that is a threshold time period used to determine whether link status transitions to the Recovery state (a recovery determination time period ST3) and longer than 30 μs.

That is, the time period d2 for UpdateFC signal transmission is shorter than the threshold time period ST3 that is a determination reference time period used to determine whether operation mode of the communication circuit 24c transitions to the Recovery state defined in the adopted communication architecture.

If transmission data is absent, and the reception buffer 22a is empty when the first enable register 26a is set to “1,” and the second enable register 26b is set to “1,” the communication control section 12a does not transmit an UpdateFC signal until transmission data appears. The expanded L0s function of the communication control section 13a of the switch 13 that is the device as the communication partner is enabled, and a timer for Recovery state determination is off. Accordingly, even if the communication control section 12a does not transmit an UpdateFC signal, the link status does not transition to the Recovery state.

Each communication control section has configuration information indicating whether the communication control section itself has an expanded L0s function, and the information is set in the first enable register 26a. Since configuration information indicating whether a communication partner has an expanded L0s function is also set in the first enable register 26a of the communication partner, each communication control section sets presence or absence of an expanded L0s function in the communication control section and the communication partner in the first and second enable registers 26a and 26b of the communication control section.

Values of the first and second enable registers 26a and 26b are set in advance. For example, an enable register setting program of the communication control section 12a performs communication between the communication control sections 12a and 13a, and the communication control section 12a obtains the configuration information (information on whether an expanded L0s function is enabled) in the communication control section 13a in advance. With the operation, the second enable register 26b is set in advance. If an expanded L0s function is enabled in the communication control section 13a, the communication control section 12a sets the second enable register 26b to “1.” Note that the second enable register 26b may not be set in advance and that it is possible to check the first enable register 26a at the communication partner after the start of communication and set the second enable register 26b at this end.

Link status and the Recovery state in the PCI Express architecture will be described.

The PCI Express architecture has an LTSSM function for link status management and defines the L0s state that is a low-power state implemented by hardware as one link state.

The L0s state is a state to which the link status transitions spontaneously if packet data as transmission data is absent or packet data cannot be transmitted. In the L0s state, power saving is achieved by, e.g., lowering voltages to be supplied to various circuits.

However, according to the PCI Express architecture standard, even in, e.g., a case where transmission data is absent after the link status transitions to the L0s state, the link status transitions to the L0 state that is a normal state in order to transmit an UpdateFC signal at time intervals of the predetermined time period d1 (e.g., 30 μs) defined in advance and then returns to the L0s state. That is, even in, e.g., a case where transmission data is absent after the link status transitions to the L0s state, a transition from the L0 state to the L0s state and a transition from the L0s state to the L0 state are repeated. For the reason, the L0s state corresponding to power saving mode cannot continue after a lapse of the predetermined time period d1.

Under the circumstances, the present embodiment is configured such that the L0s state corresponding to power saving mode can continue even after a lapse of a predetermined time period in, e.g., a case where an transmission packet is absent after the link status transitions to the L0s state.

### (Operation)

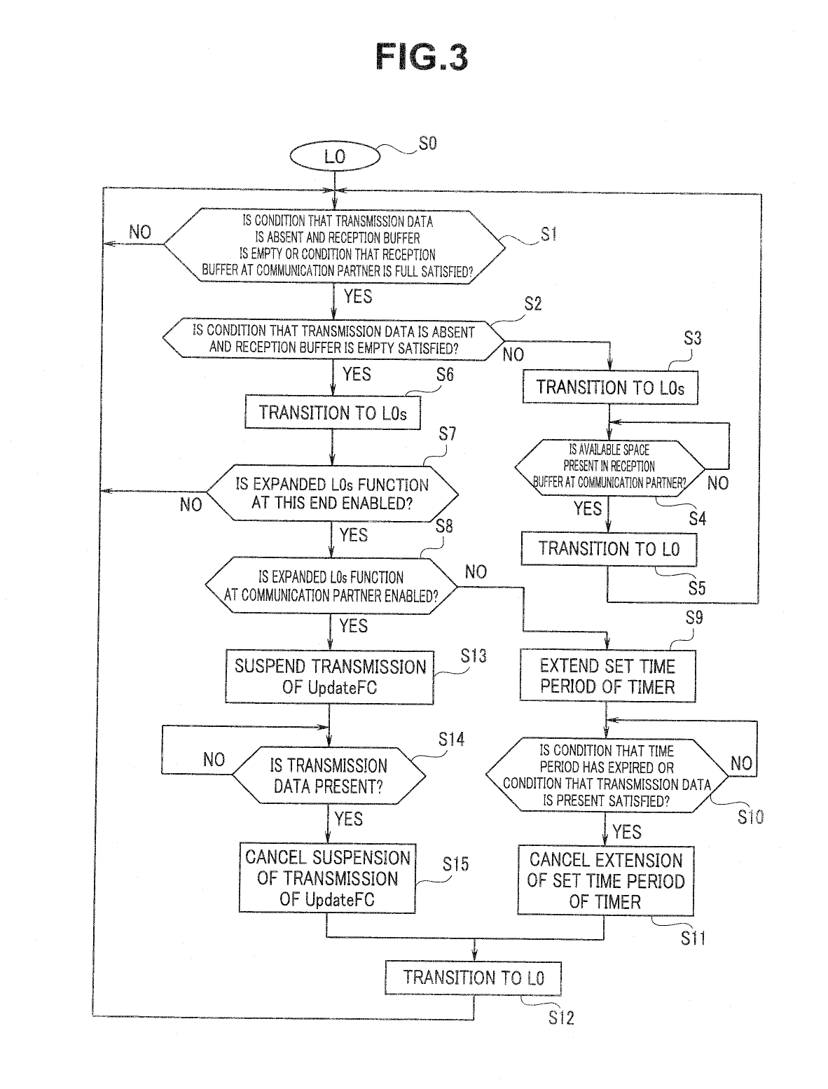

FIG. 3 is a flow chart showing a flow of state transition by processing of the power management control section 25. A function of the power management control section 25 may be implemented by a software program or by a hardware circuit.

The link status is initially set to the L0 state (step S0).

The power management control section 25 determines whether the condition that transmission data is absent and the reception buffer 22a is empty or the condition that a reception buffer at the communication partner (i.e., the reception buffer of the communication control section 13a) is full is satisfied (step S1). In step S1, whether a condition for transition to the L0s state in the LTSSM function is satisfied is determined.

If transmission data is present, if the reception buffer 22a is not empty, or if the reception buffer at the communication partner is not full (NO in step S1), the link status does not transition to the L0s state.

If transmission data is absent, and the reception buffer 22a is empty or if the reception buffer at the communication partner is full (YES in step S1), the power management control section 25 determines whether transmission data is absent and the reception buffer 22a is empty (step S2).

Whether transmission data is present is determined based on whether a state without transmission data continues for a set time period ST2 (e.g. 7 μs) set in one timer of the timer section 25b. That is, if a state without transmission data to be transmitted continues for the predetermined time period ST2, the power management control section 25 determines that transmission data is absent. Accordingly, if a state without transmission data continues for the set time period ST2 of the timer section 25b, it is determined that transmission data is absent.

The power management control section 25 can determine presence or absence of transmission data by monitoring a signal output from the bus I/F 21 to the transmission buffer 23a. The power management control section 25 can also determine, from a state in which reception data is stored (or an empty state), whether the reception buffer 22a, in which reception data is stored via the differential circuit 24b, is empty by referring to the reception buffer 22a.

The power management control section 25 can also determine from available space in the reception buffer included in an UpdateFC signal from the communication control section 13a as the communication partner whether the reception buffer of the switch 13 at the communication partner is full.

If transmission data is present or if the reception buffer 22a is not empty (NO in step S2), and the reception buffer at the communication partner is full, the power management control section 25 makes a transition of the link status to the L0s state (step S3).

The power management control section 25 determines whether available space is present in the reception buffer at the communication partner (the reception buffer of the communication control section 13a) (step S4). If available space is absent in the reception buffer at the communication partner (NO in step S4), the power management control section 25 does not transmit transmission data, if any.

That is, in the case, an UpdateFC signal is transmitted at intervals of the predetermined time period d1 from the communication partner as usual.

If available space is present in the reception buffer at the communication partner (YES in step S4), the power management control section 25 makes a transition of the link status to the L0 state (step S5). As a result, the communication control section 12a can transmit transmission data. After the process in step S5. the flow returns to step S1.

If transmission data is absent, and the reception buffer 22a is empty (YES in step S2), the power management control section 25 makes a transition of the link status to the L0s state (step S6).

The power management control section 25 determines whether the expanded L0s function is enabled by the first enable register 26a (step S7).

If the expanded L0s function is disabled in the communication control section 12a by the first enable register 26a (NO in step S7), the flow shifts to step S1.

If the expanded L0s function is enabled by the first enable register 26a (YES in step S7), the power management control section 25 determines whether the expanded L0s function is enabled in the communication partner by the second enable register 26b (step S8).

If the expanded L0s function is disabled in the communication control section as the communication partner by the second enable register 26b (NO in step S8), the power management control section 25 extends the set time period ST1 of the timer 23c in the UpdateFC transmission control section 23b by setting the set time period ST1 to the predetermined time period d2 (e.g. 180 μs) (step S9).

As described above, if, during operation of the communication circuit 24c in normal mode, transmission data is absent and reception data is absent in the reception buffer 22a (YES in step S2), the power management control section 25 controls the UpdateFC transmission control section 23b that is a predetermined information transmission section to make a transition of the operation mode of the communication circuit 24c to low-power mode (step S6) and transmit an UpdateFC signal as predetermined information at intervals of the predetermined time period d2 longer than the predetermined time period d1 (step S9).

The predetermined time period d2 is a time period shorter than the recovery determination time period ST3 that is set as a threshold value for transition to the Recovery state defined in the PCI Express architecture. The predetermined time period d2 for operating a re-training function (to be described later) will suffice if the predetermined time period d2 is about 90% of the recovery determination time period ST3. Accordingly, if the recovery determination time period ST3 is, for example, 200 μs, the predetermined time period d2 is 180 μs. Since duration of the L0s state can be extended, power consumption can be reduced.

The power management control section 25 determines whether the condition that the timer 23c in the UpdateFC transmission control section 23b has counted to the predetermined time period d2 or the condition that transmission data is present is satisfied (step S10). If the timer has not expired or if transmission data is absent (NO in step S10), the flow returns to step S10 to continue monitoring of the timer 23c and transmission data.

If the timer 23c in the UpdateFC transmission control section 23b has expired or if transmission data is present (YES in step S10). the power management control section 25 cancels the extension of the set time period ST1 of the timer 23c started in step S9 (step S11). By the cancellation of the extension of the set time period ST1 of the timer 23c, the original predetermined time period d1 (30 μs in the present embodiment) is set as the set time period ST1 in the timer 23c.

The power management control section 25 makes a transition of the link status to the L0 state (step S12). As a result, the communication control section 12a can transmit transmission data. After the process in step S12, the flow returns to step S1.

As described above, if, during operation of the communication circuit 24c in low-power mode, transmission data is present or the predetermined time period d2 elapses (YES in step S10), the power management control section 25 controls the UpdateFC transmission control section 23b that is the predetermined information transmission section to transmit an UpdateFC signal at time intervals of the predetermined time period d1 (step S11) and make a transition of the operation mode of the communication circuit 24c to normal mode corresponding to the L0 state (step S12).

If the value of the enable register 26b is “1,”, that is, the expanded L0s function is also enabled in the communication control section at the communication partner (YES in step S8), the power management control section 25 controls the UpdateFC transmission control section 23b to suspend transmission of an UpdateFC signal (step S13).

If the expanded L0s function is also enabled in the communication control section 13a as the communication partner, the timer used to determine whether the link status transitions to the Recovery state is disabled in the communication control section 13a.

In the PCI Express architecture, if a state in which no packet is received from a communication partner continues for a predetermined time period (the recovery determination time period ST3) or longer, it is generally necessary to make a transition of status of a link to the Recovery state, to which the link status shifts in the event of a problem, and re-train the link. The timer is used to determine whether no data is received from the communication partner for the recovery determination time period ST3 or longer.

If the expanded L0s function is enabled, the communication control section (the communication control section 13a in the present embodiment) does not perform recovery transition determination based on the timer. Since information on whether the expanded L0s function is set in the communication control section (the communication control section 13a in the present embodiment) as the communication partner is set in the second enable register 26b of the communication control section 12a, the power management control section 25 can make the determination in step S8.

After that, the power management control section 25 determines whether transmission data is present (step S14). If transmission data is absent (NO in step S14), the power management control section 25 does nothing.

If transmission data is present (YES in step S14). the power management control section 25 cancels the suspension of transmission of an UpdateFC signal (step S15). The power management control section 25 makes a transition of the link status to the L0 state (step S12), and the flow returns to step S1.

That is, if, during operation of the communication circuit 24c in normal mode, transmission data is absent and reception data is absent in the reception buffer 22a (YES in step S2), the power management control section 25 controls the UpdateFC transmission control section 23b that is the predetermined information transmission section to suspend the transmission of an UpdateFC signal based on information in the second enable register 26b on a communication partner with which communication is performed by the communication circuit 24c (step S13). If transmission data is present after the suspension of transmission of an UpdateFC signal, the power management control section 25 controls the UpdateFC transmission control section 23b to cancel the suspension of transmission of an UpdateFC signal (step S15) and make a transition of the operation mode of the communication circuit 24c to normal mode (step S12).

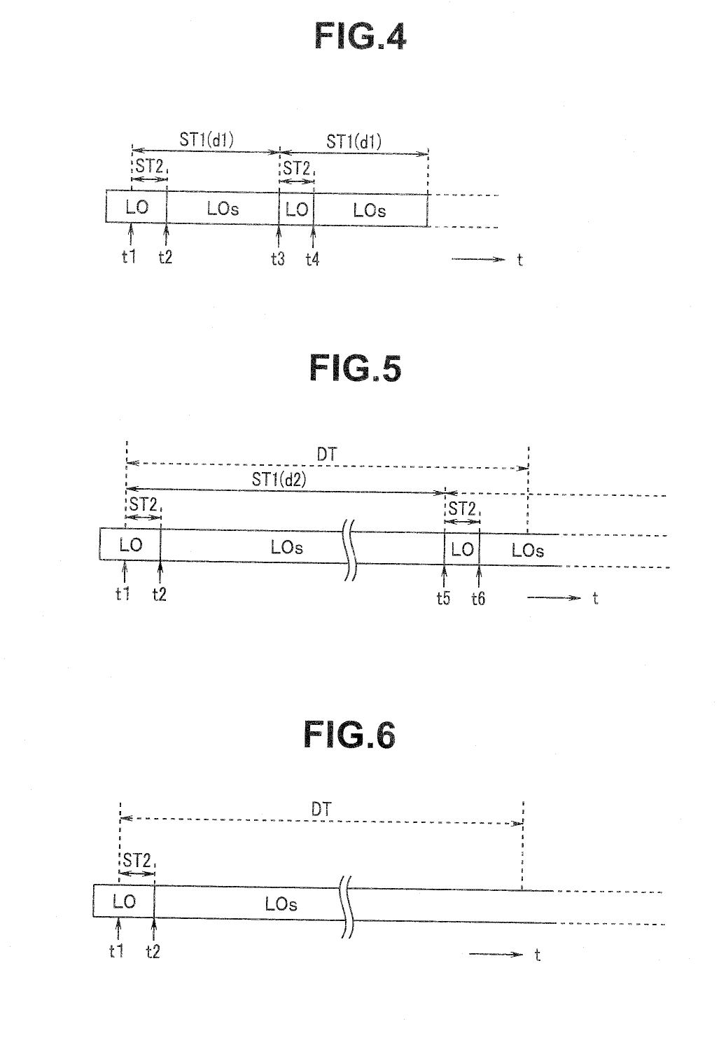

FIG. 4 is a time chart for describing a case where a change from the L0 state to the L0s state and a change from the L0s state to the L0 state are alternated with passage of time t when the expanded L0s function is disabled.

As shown in FIG. 4, if a state in which transmission data is absent and the reception buffer 22a is empty continues for the set time period ST2 (e.g., 7 μs) set in the timer section 25b from a certain time t1, the link status transitions from the L0 state to the L0s state. In FIG. 4, the link status transitions from the L0 state to the L0s state at a time t2.

At a time t3, the set time period ST1 (e.g., d1=30 μs) of the timer 23c expires, and the link status transitions from the L0s state to the L0 state. At a time t4. since a state in which transmission data is absent and the reception buffer 22a is empty has continued for the set time period ST2 (e.g. 7 is) set in the timer section 25b, the link status transitions from the 1.0 state to the L0s state.

In FIG. 4, same operation is repeated after the transition.

FIG. 5 is a time chart for describing a case where duration of the L0s state is extended. In the present embodiment, if YES in step S7 and NO in step S8 of FIG. 3, the set time period ST1 (e.g., d1=180 μs) of the timer 23c is extended (step S9).

As shown in FIG. 5, at a time t5, since the extended set time period ST1 of the timer 23c has expired, the link status transitions from the L0s state to the L0 state. At a time t6, since a state in which transmission data is absent and the reception buffer 22a is empty has continued for the set time period ST2 (e.g., 7 μs) set in the timer section 25b, the link status transitions from the L0 state to the L0s state.

In FIG. 5, same operation is repeated after the transition. Accordingly, if transmission data is absent, and the reception buffer 22a is empty, the number of transitions from the L0 state to the L0s state and the number of transitions from the L0s state to the L0 state are smaller in FIG. 5 than in FIG. 4. The smaller numbers show that the communication control section 12a saves power for a longer time period.

FIG. 6 is a time chart for describing a case where the L0s state continues when the expanded L0s function is enabled also in the communication partner. In the present embodiment, if YES in step S8 of FIG. 3, transmission of an UpdatcFC signal is suspended in step S13.

As shown in FIG. 6, at a time t2, the set time period ST2 of the timer section 25b has expired, and the link status thus transitions from the L0 state to the L0s state.

Additionally, since the expanded L0s function is also enabled in the communication partner, transmission of an UpdateFC signal is suspended. In the communication control section 13a as the communication partner, the timer used to determine whether the link status transitions to the Recovery state is disabled, and the link status remains in the L0s state after the transition.

The above-described processes in steps S2 and S6 to S12 constitute the expanded function section 25a.

Accordingly, since the L0s state continues until transmission data, the communication control section 12a saves power for a further longer time period in FIG. 6 than in FIG. 5.

As has been described above, according to the above-described present embodiment, a semiconductor device and a communication method which achieve a larger saving in power consumption by delaying timing of a periodic exit from low-power mode can be provided.

Note that although the configuration and operation in the PCI Express architecture have been described in the above example, a semiconductor device according to the present embodiment can also be applied to a communication architecture other than the PCI Express architecture.

Also, note that although a case where a communication control section is used for communication in a PC has been described in the above example, a communication control section according to the present embodiment can also be applied to communication in various pieces of electronic equipment, such as a cellular phone, a smartphone, and a tablet PC.

The individual “sections” in the present specification correspond to respective functions of the embodiment and are conceptual. The sections do not necessarily correspond one-to-one to specific pieces of hardware or specific software routines. Therefore, in the present specification, the embodiment has been described with virtual circuit blocks (sections) having the respective functions of the embodiment in mind. An order in which the individual steps of each procedure in the present embodiment are executed may be changed, some of the individual steps may be simultaneously executed, or the individual steps may be executed in a different order for each execution, unless contrary to nature of the individual steps.

While certain embodiments have been described, these embodiments have been presented by way of example only, and are not intended to limit the scope of the inventions. Indeed, the novel methods and devices described herein may be embodied in a variety of other forms; furthermore, various omissions, substitutions and changes in the form of the methods and devices described herein may be made without departing from the spirit of the inventions. The accompanying claims and their equivalents are intended to cover such forms or modifications as would fall within the scope and spirit of the inventions.

What is claimed is:

1. A semiconductor device including a communication circuit capable of operating in at least two operation modes including a first operation mode and a second operation mode lower in power consumption than the first operation mode, comprising:
a transmission buffer configured to store transmission data;
a reception buffer configured to store reception data:
a predetermined information transmission section configured to transmit predetermined information at intervals of a first time period; and
a power management control section configured to control the predetermined information transmission section to make a transition of an operation mode of the communication circuit to the second operation mode and transmit the predetermined information at intervals of a second time period longer than the first time period if, during operation of the communication circuit in the first operation mode, the transmission data is absent and the reception data is absent in the reception buffer.

2. The semiconductor device according to claim 1, wherein the power management control section is configured to control the predetermined information transmission section to make a transition of the operation mode of the communication circuit to the first operation mode and transmit the predetermined information at intervals of the first time period if, during operation of the communication circuit in the second operation mode, the transmission data is present or the second time period elapses.

3. The semiconductor device according to claim 1, wherein
the second time period is shorter than a determination reference time period which is used to determine whether the operation mode of the communication circuit transitions to a recovery state defined in a communication architecture adopted by the communication circuit.

4. The semiconductor device according to claim 1, wherein
first configuration information specifying whether to control the predetermined information transmission section to transmit the predetermined information at intervals of the second time period can be set.

5. The semiconductor device according to claim 1, wherein
the power management control section controls the predetermined information transmission section not to transmit the predetermined information at intervals of the second time period but to suspend transmission of the predetermined information, based on second configuration information for a communication partner with which communication is performed by the communication circuit.

6. The semiconductor device according to claim 5, wherein
the second configuration information is information indicating that transmission of the predetermined information to be transmitted to the communication circuit is suspended during operation of the communication circuit in a fourth operation mode lower in power consumption than a third operation mode.

7. The semiconductor device according to claim 1, wherein
the power management control section determines that the transmission data is absent if a state in which the transmission data to be transmitted is absent continues for a third time period.

8. The semiconductor device according to claim 1, wherein
the predetermined information is flow control information including information on available space in the reception buffer, and
the predetermined information transmission section is a flow control section configured to transmit the flow control information.

9. The semiconductor device according to claim 1, wherein
a communication architecture adopted by the communication circuit is PCI Express, and the predetermined information is an UpdateFC packet.

10. A semiconductor device including a communication circuit capable of operating in at least two operation modes including a first operation mode and a second operation mode lower in power consumption than the first operation mode, comprising:
a transmission buffer configured to store transmission data;
a reception buffer configured to store reception data; and
a power management control section configured to control a predetermined information transmission section to suspend transmission of predetermined information based on second configuration information for a communication partner with which communication is performed by the communication circuit if, during operation of the communication circuit in the first operation mode, the transmission data is absent and the reception data is absent in the reception buffer.

11. The semiconductor device according to claim 10, wherein the power management control section is configured to control the predetermined information transmission section to cancel suspension of transmission of the predetermined information and make a transition of operation mode of the communication circuit to the first operation mode if the transmission data is present after suspension of transmission of the predetermined information.

12. The semiconductor device according to claim 11, wherein
the communication architecture adopted by the communication circuit is PCI Express, and the predetermined information is an UpdateFC packet.

13. A communication method for performing communication by a communication circuit capable of operating in at least two operation modes including a first operation mode and a second operation mode lower in power consumption than the first operation mode, comprising:
transmitting predetermined information at intervals of a first time period by a predetermined information transmission section; and
controlling the predetermined information transmission section to make a transition of an operation mode of the communication circuit to the second operation mode and transmit the predetermined information at intervals of a second time period longer than the first time period if, during operation of the communication circuit in the first operation mode, the transmission data is absent and the reception data is absent in the reception buffer.

14. The communication method according to claim 13, further comprising controlling the predetermined information transmission section to make a transition of the operation mode of the communication circuit to the first operation mode and transmit the predetermined information at intervals of the first time period if, during operation of the communication circuit in the second operation mode, the transmission data is present or the second time period elapses.

15. The communication method according to claim 13, wherein
the second time period is shorter than a determination reference time period which is used to determine whether the operation mode of the communication circuit transitions to a recovery state defined in a communication architecture adopted by the communication circuit.

16. The communication method according to claim 13, wherein
first configuration information specifying whether to control the predetermined information transmission section to transmit the predetermined information at intervals of the second time period can be set.

17. The communication method according to claim 13, further comprising:
controlling the predetermined information transmission section not to transmit the predetermined information at intervals of the second time period but to suspend transmission of the predetermined information, based on second configuration information for a communication partner with which communication is performed by the communication circuit.

18. The communication method according to claim 17, wherein
the second configuration information is information indicating that transmission of the predetermined information to be transmitted to the communication circuit is suspended during operation of the communication circuit in a fourth operation mode lower in power consumption than a third operation mode.

19. The communication method according to claim 13, wherein
the predetermined information is flow control information including information on available space in the reception buffer, and the predetermined information transmission section is a flow control section configured to transmit the flow control information.

20. The communication method according to claim 13, wherein
a communication architecture adopted by the communication circuit is PCI Express, and the predetermined information is an UpdateFC packet.
